(19) United States
(12) Patent Application Publication
(10) Pub. No.: US 2005/0150077 A1
(43) Pub. Date: Jul. 14, 2005

(54) Clamp, pressand hinge system which is formed from curved and straight folds which are applied to laminate materials

(75) Inventor: Naoko Takeda Toda, Col. Condesa, Mexico D. F. CP (MX)

Correspondence Address: MICHAEL WINFIELD GOLTRY, 4000 N. CENTRAL AVENUE, SUITE 1220, PHOENIX, AZ, 85012, US

(73) Assignee: IKERUDESIGN, S.A. DE C.V., Monterrey, Nuevo Leon C.P. (MX)

(21) Appl. No.: 10/505,545

(22) PCT Filed: Jan. 8, 2003
(86) PCT No.: PCT/MX03/00001

(30) Foreign Application Priority Data
Feb. 27, 2002 (MX) NL/A/2002/000008
Mar. 8, 2002 (MX) NL/U/2002/000004

(51) Int. Cl. E05D 1/00

(52) U.S. Cl. 16/221

(57) ABSTRACT

The invention relates to a structure comprising at least two sets of folds which is made from laminated materials, such as paper, board, plastic, metal or any other material that is sufficiently rigid and flexible in order to be structured and folded. Each of the aforementioned sets of folds is formed by one curved fold and another straight fold which are folded in opposite directions. The purpose of the invention is to provide a novel pressing or clamping mechanism and a hinge mechanism which is intended for use in the design of articles such as plates, containers, clamps, articles bearing laminate objects and/or volumes, packaging and lamp shades and for use as a hinge device for articles such as doors and lids or with hinged parts. According to the invention, the structure comprises folds which are made from the central area of the laminate, which forces the outer area of said laminate to form the walls of the structure and, thereby, prevent spillages. In this way, containers designed with said structure system can be used to contain liquids without any spillages occurring if the container is made from an impermeable material, such as plastic. The invention can be used to produce products having an innovative design at a low cost using traditional methods such as die cutting and punching. The invention serves to reduce the area needed for the storage and transport of the above-mentioned products, since the finished product can comprise one flat laminate, and thereby reduces the production and labour costs of same.

### BACKROUND OF THE INVENTION

This invention starts from a the study of curved and straight folds applied to laminated materials such as paper or cardboard, plastics like polypropylene and metallic laminates such as steel or aluminum.

The combination of straight and curved folds arranged in a certain way and applied to laminates with a determined level of rigidity creates a structure capable of setting or anchoring by itself, thereby creating in turn a subjecting, pressing or clamping mechanism and a hinge mechanism. To achieve the self-set, no cutting of the same sheet is required, nor is some joining technique like glue or gum, thermal sealing, welding or else extra elements like staples, screws, nails, rivets or adhesive tape.

This invention can be applied for the construction of diverse articles such as receptacles, plates, packaging, lampshades, carriers for laminated objects, toilet paper rollers, carriers for balls or spheres. Specifically is mentioned a compact disc or CD carriers, receptacles such as plates to contain snacks, fast food or salads, adhesive tape dispensers, rollers for rolls of toilet paper, picture frames, portfolios, lampshades, and clips or clamp.

In the actuality there exists articles made with laminates which are structured with folds, however it is necessary to utilize one of the joining techniques such as gluing, thermal sealing, and welding, or else the use of additional elements like staples, screws, nails, rivets or adhesive tape. The present invention eliminates the use of said joining techniques or additional elements, and thereby reduces the production and labour costs.

The process to carry out the marking of the straight and curved lines that serve as guides for the folds that will make up the structure of the invention is determined by the material with which one wishes to work. That is, in the case of thick paper or thin cardboard and some plastics like polypropylene, these can be submitted to the process of die-cutting; in the case of laminated metals, the adequate process would be punching.

### DESCRIPTION OF THE INVENTION

### BRIEF DESCRIPTION OF THE DRAWINGS

FIG. 1 represents a view of a pattern to form an structure.

FIG. 2 represents a variation of view of the pattern form the FIG. 1.

FIG. 3 represents a view of a second variation the pattern form the FIG. 1.

FIG. 4 represents a view of the pattern with a minimum number of set of folds that a laminated sheet must have to form an structure like a receptacle.

FIG. 5 is a set of drawings that represent the sequence of the forming of the structure.

FIGS. 6, 7, and 8 are different views of the structure once formed and folded, wherein FIG. 6 is a top view, FIG. 7 is a front view, this being substantially the same on all four sides, and FIG. 8 represents the bottom view.

FIGS. 9, 10, and 11 represent some different depths that can occur in the structure, wherein FIG. 9 represents the structure formed or folded from FIG. 1, FIG. 10 represents the structure formed from FIG. 2, and FIG. 11 represents the structure formed from FIG. 3.

FIGS. 12, 13, and 14 represent variations of the pattern of the FIG. 4, which represent different positions in which the folds can be placed.

FIG. 15 represents a variation of view of the pattern to form a different option of the structure of FIGS. 1, 2, 3, and 4.

FIGS. 16, 17, 18 and 19 are different views of the structure once formed or folded, wherein FIG. 16 represents a top view, FIG. 17 is the front view, with the rear view being substantially the same, FIG. 18 represents the bottom view, and FIG. 19 is the right lateral view, with the left lateral view being substantially the same.

FIG. 20 is a set of drawings that represent the sequence of the forming of the structure.

FIG. 21 represents the hinge movement in two steps.

FIG. 22 is the lateral view of the down structure.

The characteristic details of this novel structuring system and clamp are clearly disclosed in the following description in conjunction with the 22 accompanying drawings or figures, following the same reference labels to indicate the parts that conform the elements of the invention and shown figures.

It should be mentioned that the drawings or figures presented here, show the design of a receptacle or lampshades, and a compact disc or CD carriers, which are two examples of the many products that can be developed on base of this invention of structuring mechanism and clamp.

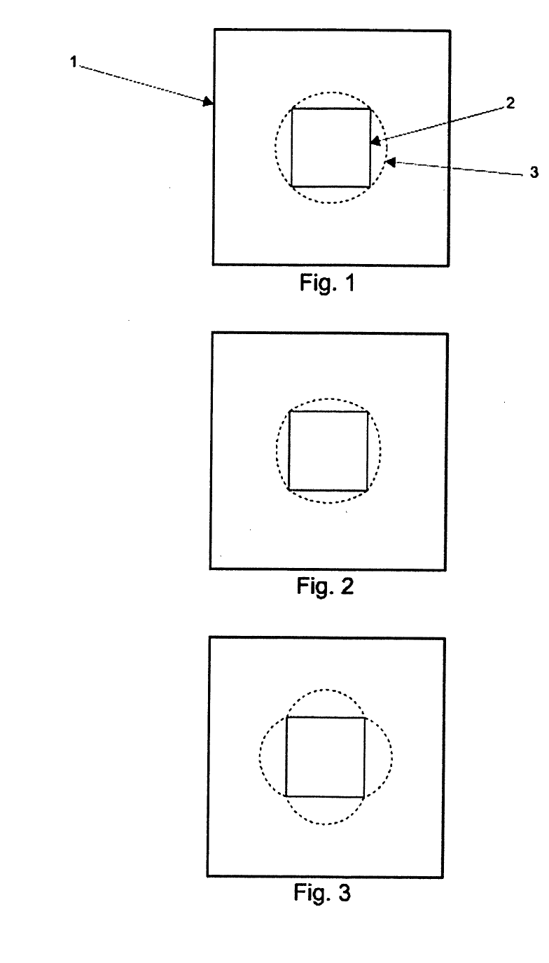

FIG. 1 is the development that can have the sheet, once that it is die cut or punched which is previously marked with lines that will serve as guides to make the folds. The reference 1 of FIG. 1 indicates the limit of the sheet, which in this case has the form of a square although this can be varied. The reference 2 of FIG. 1 marks one of the straight lines which are represented by continued lines, the reference 3 of FIG. 1 marks one of the curved lines which are drawing with dotted lines. All the lines represented by continued lines fold in the same direction, while the lines represented by dotted lines fold in the inverse direction with regards to the straight lines.

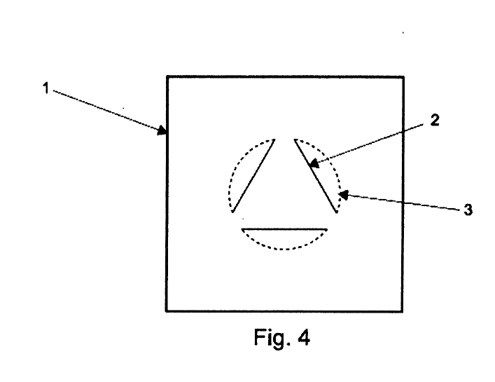

In FIG. 4 is observed how each curved section intersects a straight, this combination of one curved fold and one straight folds in inverse direction creates the set-self or clamp of the structure of the sheet. In the case of the pattern of FIG. 4, where the curved folds are arranged in a circle and the straight folds are arranged in a triangle, this arrangement causes that when they are folded in inverse directions, they form a structure like a receptacle. In FIGS. 1, 2, and 3, the composition of folds is formed by four (4) pairs of curved and straight folds, with the result that the straight folds trace a square and the curved folds trace a circumference or a quasi-circumference.

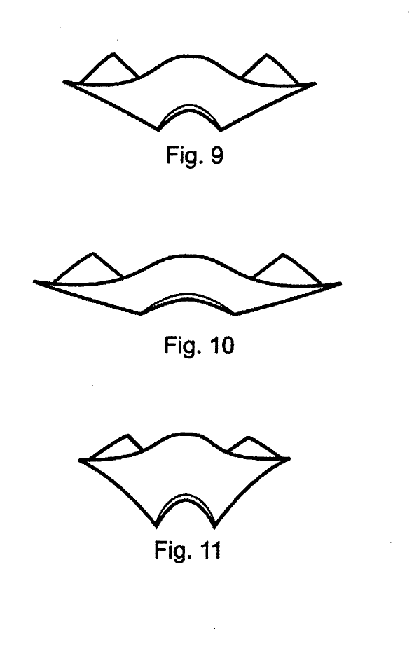

Taking as a basis the pattern represented in FIG. 1, the FIGS. 2 and 3 show views of variations of the pattern. The difference rests in the curved folds. The pattern of FIG. 2 is represented with arcs or curves that has a greater radius with regards to the arcs of base pattern and the arcs of the pattern 3 has a minor radius in comparison with the arcs of base pattern, such that for a minor radius the depth of the receptacle will be greater. The FIGS. 9, 10, and 11 show different depths, FIG. 9 corresponds to FIG. 1 once that it is folded, FIG. 10 corresponds to FIG. 2 once that it is folded and FIG. 11 corresponds to FIG. 3 once that it is folded.

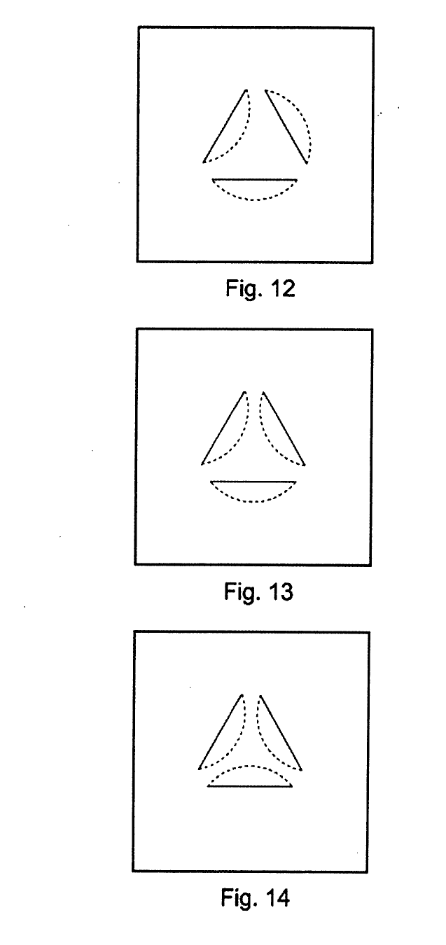

So the receptacle can be formed, there must be a minimum of three sets of curved and straight fold, which is shown in FIG. 4. It should be mentioned that it is not strictly rigorous that they be positioned in the center of the pattern, nor is it perforce that the arrangement of the folds be equidistant from each other. Quite the contrary, their arrangement can vary, i.e., the curves can be placed closer to the exterior of the pattern with regards to its straight or viceversa, which is shown in the FIGS. 12, 13, and 14.

FIG. 12 shows two set of curved and straight folds, where the curved lines are placed closer to the limit or perimeter of the pattern with regards to the straight lines, and only one set of folds where the position of the straight line is placed closer to the limit or perimeter of the pattern with regards to its curved line.

FIG. 13 is the opposite of the pattern in FIG. 12, insofar as the two of three sets of folds present their curved lines closer to the center of pattern and just one set of folds wherein their straight line is placed closer to the center of pattern with regards to its curved line.

The pattern in FIG. 14 represents the contrary of the pattern in FIG. 4 insofar as the three sets of folds have their curved lines closer to the center of pattern with regards to their straight lines.

The objective of showing the different patterns represented in FIGS. 1, 2, 3, 4, 12, 13, and 14 is to demonstrate that the composition of the sets of folds on the patterns can be widely varied without affecting the possibility of obtaining a structure like a receptacle. However, it can affect the rigidity and resistance to the different forces to which the structure may be submitted. That is, depending on the position of the sets of folds and the dimensions of the same we can obtain stronger or weaker structures, as well as structures that can return with greater or minor ease to their original flat state, or quite the contrary that will not return.

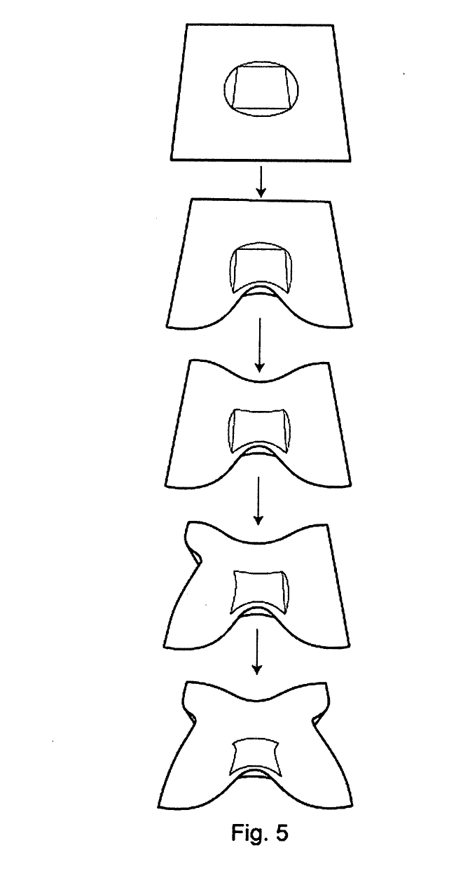

The set of drawings of FIG. 5 represents the folding process to carry out the invention taking as example the pattern of FIG. 1; this FIG. 5 represents the sequence of how the laminated material forms a structure like a receptacle, step by step, accordingly each set of curved and straight folds is folded.

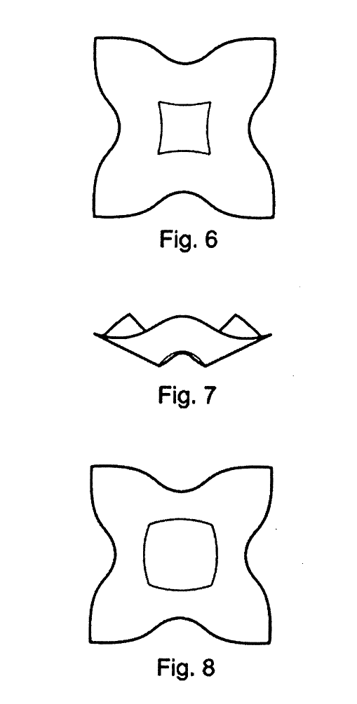

The FIGS. 6, 7, and 8 are the views of the invention of pattern of FIG. 1 once it is structured, i.e., folded. Wherein FIG. 6 represents the top view, FIG. 7 is the front view, this being substantially the same on all four sides, and FIG. 8 is the bottom view.

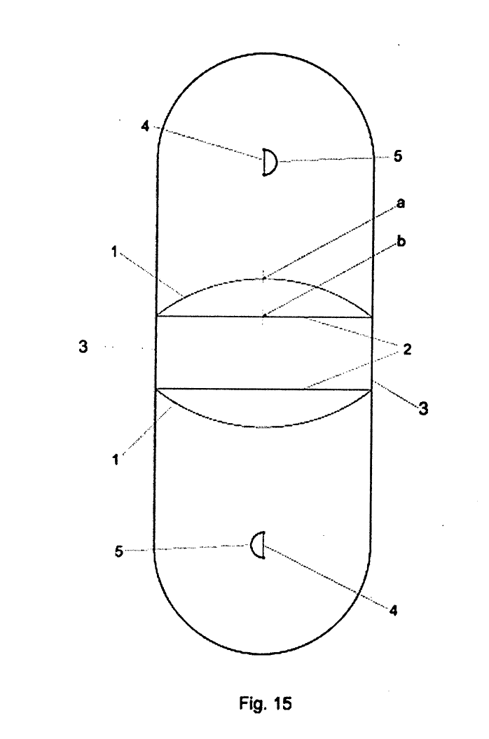

The FIG. 15 represents the development of an option that can have the pattern once it is die cut or punched, the reference 1 indicates the curved folds and the reference 2 indicates the straight folds. How can be observed in FIG. 15, this combination of a curved fold and a straight fold in inverse directions creates the self-set of the structure of the pattern. The radius of the curved fold can vary and the smaller the radius, the stronger will be this self-set. So the mechanism of clamping can have effect, there must be a minimum of two sets of curved and straight folds. This FIG. 15 explains this minimum arrangement.

The references 3 of FIG. 15 which are also indicated in FIG. 21 and FIG. 22 shown the end portions of a base or back of the clamp which to be oppressed originates the holding of the clamp, i.e., by applying opposite forces on those end portions of the base, the clamp is opened and it is closed when the base is released from the applied press.

The minimum distance that there must be between the straight lines (width of the base, distance between the reference of the points 2 of FIG. 15) is double the distance between the straight line and the maximum point of the curved line which is intersected (distance between points “a” and “b” of FIG. 15), plus twice the thickness of the material.

The references 4 and 5 of FIG. 15, which are independent from the clamp, shown a solution option, where the structure will lend support to the article that it are going to hold, protect or subject, depending on the application to be given; in this case, here is presented a design for holding compact discs. The points 4 and 5 forms the tabs that fold down towards the internal face, which pass between the holes of the compact disc in order to subject it. This manner of holding may be utilized to support cylindrical articles such as rolls of toilet paper and adhesive tapes, which have an axis in the form of a tube. Then, depending of the figure that the clamp is going to support or hold, the tab will also vary in form and dimensions. An hole can substitute for the tabs if the object to be held is a regular or irregular geometric figure and also if the object has an axis or pivot that can be inserted in said holes. Also tabs can be combined with or replaced by giving a rough finish to the texture of the internal face of the holding arms so that said face, by being anti-slip, will keep the articles to be held from sliding, as in the case of sheets of paper, photographs or any laminate.

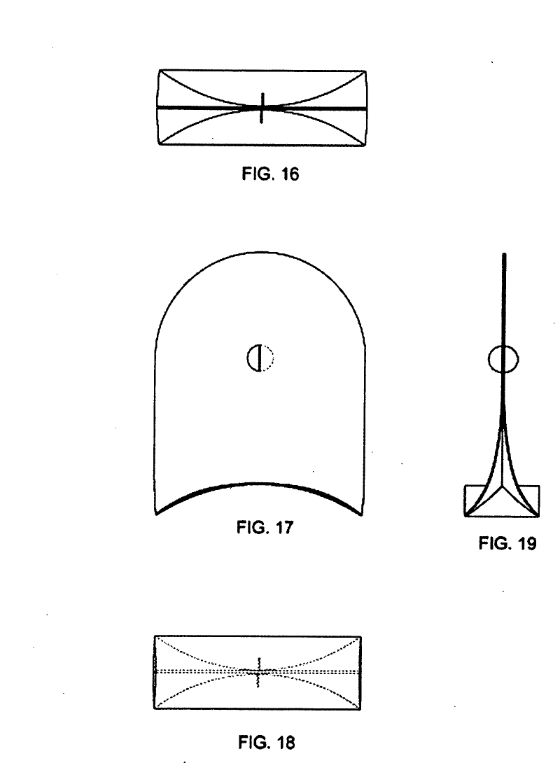

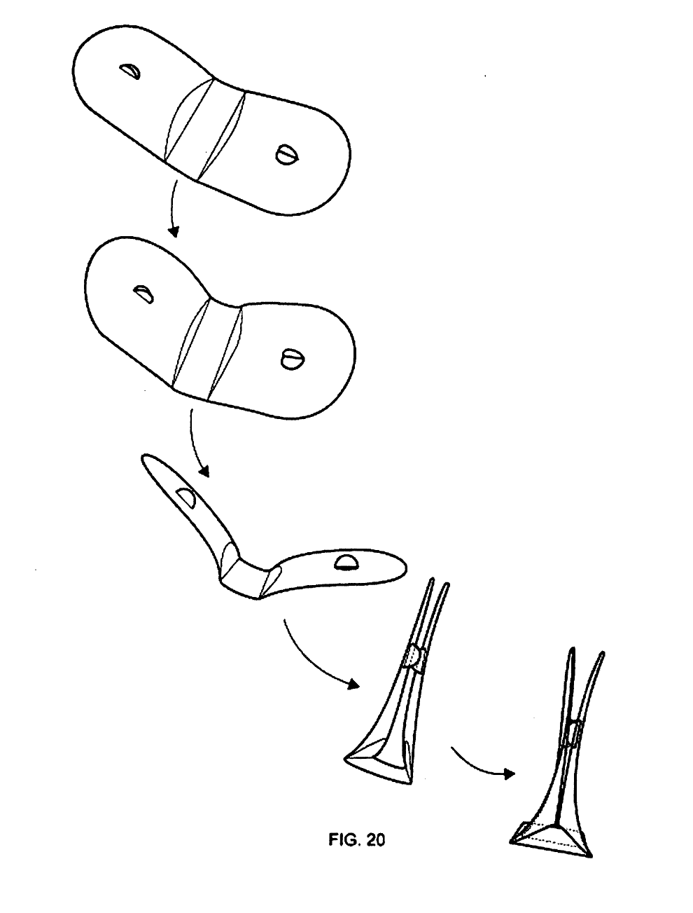

The FIGS. 16, 17, 18, and 19 are the views of the invention already structured, i.e., folded. Wherein FIG. 16 represents the top view, FIG. 17 is the front view, FIG. 18 is the bottom view and FIG. 19 is the lateral view.

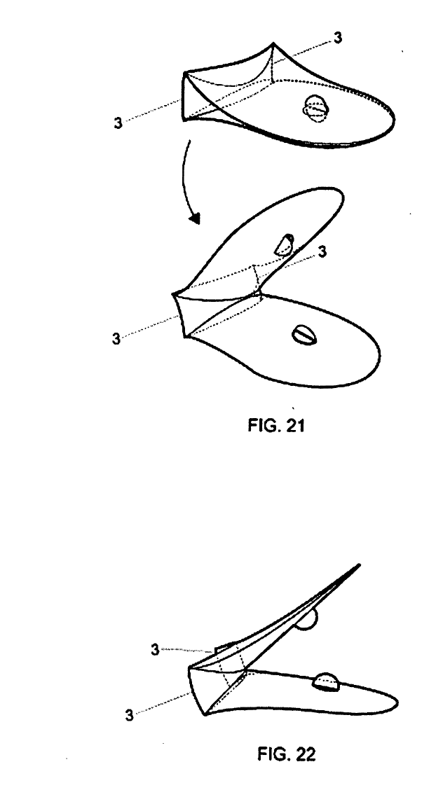

The set of drawings of FIG. 20 represents the folding process to carry out the invention.

The FIG. 21, is the set of drawings that represents the novel system in action, i.e., the manner to carry out the hinging and the manner in that the clamp is open or closed. The FIG. 22. is another view in support to the hinging.

1-9. (canceled)

10. A laminate structure, comprising:
a sheet of laminated material;
sets of folds formed in the sheet; and
each of the sets of folds comprising a curved fold and a straight fold, which are folded in opposite directions.

11. The laminate structure according to claim 10, wherein the sets of folds further comprise three sets of folds, wherein the three sets of folds are arranged circumferentially forming a receptacle.

12. The laminate structure according to claim 10, further comprising a section forming a base separating the sets of folds.

13. A clamp formed with the laminate structure according to claim 10.

14. A clamp, formed with the laminate structure of claim 10, having tabs for subjection of an object.

15. A clamp, formed with the laminate structure of claim 10, having an anti-slip surface.

16. A clamp, formed with the laminate structure of claim 10, having holes permitting subjection of a volumetric object.

17. The hinge formed with the laminate structure according to claim 10.
